(19) United States
(12) Patent Application Publication
(10) Pub. No.: US 2026/0260529 A1
(43) Pub. Date: Sep. 3, 2026

(54) ELECTRONIC LOCKSET WITH AUTHENTICATION ZONE BASED ON SENSOR DATA

(71) Applicant: ASSA ABLOY Americas Residential Inc., New Haven, CT (US)

(72) Inventors: Kevin Coleman, Lake Forest, CA (US); Matthew Denton Lovett, Rancho Santa Margarita, CA (US); Kevin Pasma, Lake Forest, CA (US); Musa Mustafa

(21) Appl. No.: 19/458,081

(22) Filed: Jan. 23, 2026

Related U.S. Application Data
(60) Provisional application No. 63/748,819, filed on Jan. 23, 2025.

(51) Int. Cl. G07C 9/22; G06T 7/579; G06V 20/13; G07C 9/00; H04W 4/02; H04W 4/80

(52) U.S. Cl. CPC G07C 9/22; G06T 7/579; G06V 20/13; G07C 9/00309; H04W 4/025; H04W 4/80; G07C 2009/00793; G07C 2209/63

(57) ABSTRACT

In general, an electronic lockset with an authentication zone based on sensor data is disclosed. The lockset may determine to actuate a locking mechanism based in part on whether a user or a user device is located in the authentication zone and whether the user is approaching or moving away from the lockset. The authentication zone may be generated based on sensor data captured by a computing device walking around a premises. For example, the sensor data may include at least one of inertial measurement unit data, GPS data, and images captured by a camera of the computing device. The sensor data may be input to a localization algorithm which generates a boundary map of the premises defining the interior and exterior of the premises. The authentication zone may be defined within the boundary map.

### CROSS-REFERENCE TO RELATED APPLICATIONS

This application claims priority to U.S. Provisional Patent Application No. 63/748,819, filed Jan. 23, 2025, the disclosure of which is incorporated herein by reference in its entirety.

### BACKGROUND

Some electronic locksets may be actuated in response to wirelessly receiving credentials from a user or a device. In some instances, the user's location relative to the lock may be an important consideration in determining whether the user wants to actuate the lock. For example, if the user is on the inside of a premises to which the lockset is attached, the user may not want to actuate the electronic lockset, even though the user or a user device may be in communication range with the electronic lockset. However, it may be challenging for a lockset to determine whether the user is inside of the premises or outside of the premises, given that the dimensions of the premises and the lockset position and orientation relative to these dimensions may vary from one doorway configuration to the next.

### SUMMARY

In general, an electronic lock with an authentication zone based on sensor data is disclosed. Based on the authentication zone, it may be determined whether an electronic lockset is to be actuated. For example, the electronic lockset may automatically lock or unlock when an authorized user is determined to be within the authentication zone. In some embodiments, additional authentication of the user may be performed before the electronic lockset is actuated. In an example, credentials may be transmitted from a computing device of the user to the electronic lockset to authenticate the user.

In examples, the authentication zone is defined based on sensor data collected by a computing device as a user walks around a premises. In other examples, the sensor data may include sensor data from a sensor of the electronic lockset, or other devices within an environment proximate to the electronic lockset.

In a first aspect, an electronic lockset is provided. The electronic lockset includes a communication interface, a processor, and a memory storing instructions. Execution of the instructions by the processor causes the electronic lockset to initiate a ranging communication with a computing device using the communication interface, determine a first position of the computing device relative to the electronic lockset based on the ranging communication, determine, using a predefined boundary map, whether the first position is within an authentication zone defined in the boundary map relative to the electronic lockset, determine a plurality of second positions of the computing device relative to the electronic lockset based on the ranging communication in response to a determination that the first position is within the authentication zone, determine whether the computing device is approaching the electronic lockset based on the plurality of second positions, and unlock the electronic lockset based on a determination that the computing device is approaching the electronic lockset. The boundary map is generated based on sensor data collected by the computing device. The plurality of second positions is indicative of movement of the computing device relative to the electronic lockset.

In a second aspect, a system for controlling an electronic lockset is provided. The system includes a communication interface, a processor, and a memory storing instructions. Execution of the instructions by the processor causes the system to initiate a ranging communication with an electronic lockset using the communication interface, determine a first position of the system relative to the electronic lockset based on the ranging communication, determine, using a predefined boundary map, whether the first position is within an authentication zone defined in the boundary map relative to the electronic lockset, determine a plurality of second positions of the system relative to the electronic lockset based on the ranging communication in response to a determination that the first position is within the authentication zone, and determine whether the system is approaching the electronic lockset based on the plurality of second positions. The boundary map is generated based on sensor data collected by the system. The plurality of second positions is indicative of movement of the system relative to the electronic lockset. The electronic lockset is unlocked based on a determination that the system is approaching the electronic lockset.

In a third aspect, a method for controlling an electronic lockset is provided. A ranging communication between an electronic lockset and a computing device is initiated. Based on the ranging communication, a first position of the computing device relative to the electronic lockset is determined. Whether the first position is within an authentication zone is determined using a predefined boundary map. The authentication zone is defined in the boundary map relative to the electronic lockset. The boundary map is generated based on sensor data collected by the computing device. In response to determining that the first position is within the authentication zone, a plurality of second positions of the computing device relative to the electronic lockset is determined. The plurality of second positions is indicative of movement of the computing device relative to the electronic lockset. Whether the computing device is approaching the electronic lockset is determined based on the plurality of second positions. In response to determining that the computing device is approaching the electronic lockset, the electronic lockset is unlocked.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an environment including an electronic lockset in which aspects of the present disclosure may be implemented.

FIG. 2 illustrates example configurations of secured areas.

FIG. 3 illustrates a side view of a portion of an electronic lockset usable within the environment of FIG. 1.

FIG. 4 illustrates a rear perspective view of a portion of an electronic lock usable within the environment of FIG. 1.

FIG. 5 illustrates a front perspective view of a portion of an electronic lock usable within the environment of FIG. 1.

FIG. 6 illustrates a schematic representation of an electronic lock, in accordance with aspects of the present disclosure.

FIG. 7 illustrates a schematic representation of a mobile device seen in the environment of FIG. 1.

FIG. 8 illustrates a flowchart of an example method for using an authentication zone as part of determining whether to actuate a lock.

FIG. 9 illustrates a user walking around an exterior of a premises.

FIG. 10 illustrates a user walking around an interior of a premises.

FIG. 11 illustrates an authentication zone.

FIG. 12 illustrates a lock configuration user interface.

FIG. 13 illustrates an authentication zone calibration user interface.

FIG. 14 illustrates an image capture user interface.

FIG. 15 illustrates an authentication zone user interface.

FIG. 16 illustrates a flowchart of an example method for determining an authentication zone.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As briefly described above, embodiments of the present invention relate to an electronic lock with an authentication zone based on sensor data is disclosed. The authentication zone may be an area from which the electronic lockset is wirelessly actuatable. The authentication zone may be an area that is external to a secured area to which the electronic lockset is attached. In some embodiments, the electronic lockset may be configured to wirelessly receive credentials from a user device. The electronic lockset may determine a location from which the credentials were sent. On the one hand, if the credentials were sent from a location within the authentication zone, then the electronic lockset may actuate a locking mechanism (e.g., move from a locked to an unlocked state, or vice-versa). On the other hand, if the credentials were sent from a location that is not in the authentication zone, then the electronic lockset may not actuate, even though the credentials may otherwise be associated with an authorized user. In some embodiments, the electronic lockset may be configured to automatically lock and unlock when an authorized user is within the authentication zone, even without receiving credentials from the user device. Additionally, in some embodiments, user intent may also be considered when actuating the electronic lockset. For example, to unlock the electronic lockset, a user may need to be in the authentication zone and moving towards the electronic lockset. Similarly, to lock the electronic lockset, the user may need to be in the authentication zone and moving away from the electronic lockset.

In some embodiments, the electronic lockset may use a ranging communication with the user device to determine one or more positions of the user device relative to the electronic lockset. In an example, the ranging communication may include an ultra-wide band (UWB) communication between the user device and the lockset. In embodiments, the lockset or the user device may use the UWB communication to determine a position of the user device relative to the lockset, such as by using time difference of arrival or two-way ranging. In further examples, the user device may transmit collected sensor data to the lockset using the ranging communication, and the lockset may use the sensor data collected by the user device to determine a position of the user device.

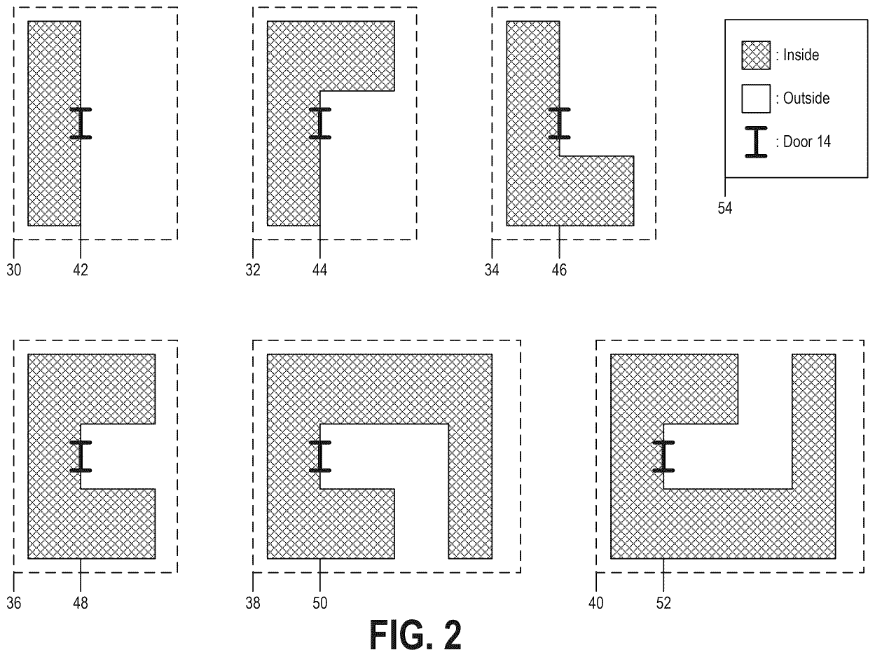

In an example aspect, the electronic lockset may be mounted to a door that is attached to a secured area, such as a building. At a side of the electronic lockset, a wall of the secured area may extend outward relative to the electronic lockset (see, for example, the example configuration 32 of FIG. 2). An authorized user or user device may be positioned in the part of the secured area that extends outward. Without a proper authentication zone, the electronic lockset may incorrectly determine that the user is outside the secured area (e.g., outside of the premises). The electronic lockset may receive credentials from the user device, and the electronic lockset may actuate a locking mechanism (e.g., moving from a locked state to an unlocked state), even though the user is inside of the premises and may not want to actuate the locking mechanism. This unexpected locking behavior may pose a security risk. For example, an intruder may be standing outside of the door, and the user may be inside and looking out the window when the user device inadvertently unlocks the door. As another example, a user may incorrectly assume that the lockset is locked when, in fact, it is unlocked, or vice-versa. By determining an authentication zone, however, this security risk may be reduced, since the authentication zone may correspond to an area that is outside of the premises, thereby ensuring that the lock may not be automatically actuated when the user device is inside.

In an example aspect, various techniques for determining an authentication zone are provided. In embodiments, a computing device collects sensor data as a user walks around a premises. In examples, the user may walk around an exterior of the premises or an interior of the premises. Examples of data collected by the computing device includes inertial measurement unit data, GPS data, images captured by a camera of the computing device, and positioning data captured during a ranging communication between the computing device and the lockset. The sensor data collected by the computing device may be used by a localization algorithm to generate a boundary map defining the interior and exterior of the premises. The authentication zone may be defined within the boundary map. For example, the authentication zone may be defined to include only an area defined to be exterior to the premises in the boundary map.

Aspects of the present disclosure provide various technical advantages. For example, an authentication zone may be defined for a lockset that is external to a secured area. By using an authentication zone to determine whether to lock or unlock, the lockset may not inadvertently cause the lockset to lock or unlock when the user is inside of a secured area. As a result, the use of the lockset may better match a user's expectations, while still retaining an ability to actuate the lockset automatically and wirelessly. Furthermore, by reducing inadvertent lock actuation, the security provided by the lockset is improved.

Yet still, techniques described herein for determining an authentication zone may be flexibly applied to different types of secured areas, such as buildings, that may have dimensions or features that vary from one site to the next. Furthermore, according to some aspects of the present disclosure, an authentication zone may be automatically determined, thereby increasing the ease of using or installing the lockset. Additionally, the manner of defining an authentication zone may be flexible defined, e.g., by defining an exterior area that corresponds to the authentication zone directly by sensors of a mobile device, electronic lockset, or other device proximate thereto, or by defining an interior area and inferentially determining the corresponding authentication zone using sensor data from the mobile device or electronic lockset or other devices proximate thereto.

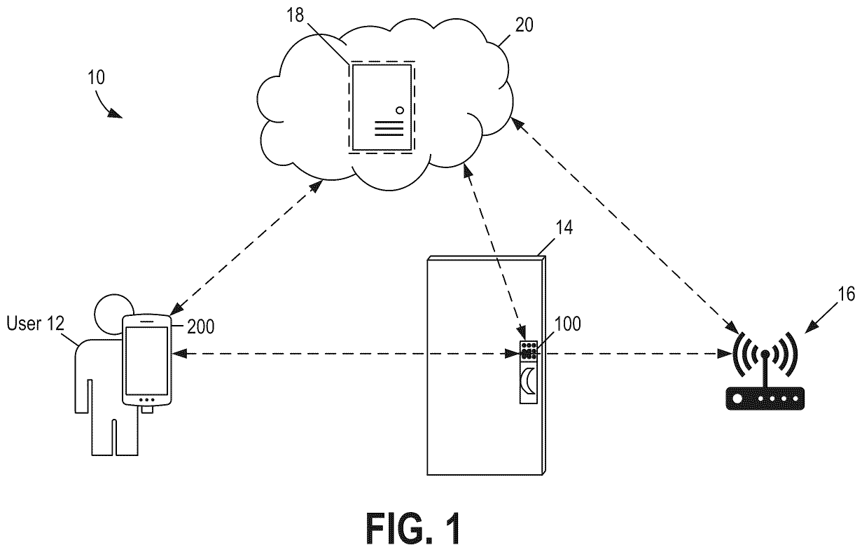

FIG. 1 illustrates an environment 10 in which aspects of the present disclosure may be implemented. The environment 10 includes a user 12, a mobile device 200, a door 14, a lockset 100, a wireless router 16, and a server 18.

The user 12 may interact with the lockset 100 to, for example, install the lockset 100, actuate a locking mechanism, check a status of the lock, update a lock setting, or perform another operation related to the lock. In some instances, the user 12 may be registered with the lockset 100 or may otherwise be authorized to actuate the lockset 100, such as an owner or tenant of the secured area where the door 14 comprising the lockset 100 is installed. In some instances, the user 12 may have a code that he or she may enter at a keypad of the lockset 100 to actuate the locking mechanism, either in addition to or to the exclusion of the user being otherwise registered or authorized at the electronic lock (e.g., via connectivity between a mobile device of the user and the electronic lock).

The door 14 may be an interior or exterior door installed at a secured area. Described below are non-limiting examples of a wireless electronic lockset mounted to the door 14. It should be noted that the lockset 100 may be used on other types of doors, such as a garage door, garden shed door, lockbox door, sliding door, doggie door, or other types of doors that require an authentication process to unlock (or lock) the door.

The lockset 100 may be an electronic lockset that is configured to lock and unlock the door 14. In some embodiments, the lockset 100 may be configured to lock or unlock the door 14 in response to receiving credentials associated with an authorized user. For example, the lockset 100 may receive and verify credentials from the mobile device 200. In some instances, prior to actuating a locking mechanism, the lockset 100 may determine whether a source of the credentials is located within an authentication zone. If it is determined that the source of the credentials is located in the authentication zone, then the lockset 100 may execute an instruction to actuate a locking mechanism. If it is determined that the source of the credentials is not located in the authentication zone, then the lockset 100 may not execute the instruction to actuate the locking mechanism. In some embodiments, the lockset 100 may include wireless communication capabilities. For example, the lockset 100 may include components for communicating with the user 12 and the mobile device 200.

The user 12 may be associated with the mobile device 200. For example, the user 12 may carry the mobile device 200 or be the owner of the mobile device 200. The mobile device 200 may be a device with wireless communication capabilities, such as a smartphone, tablet, or key fob. The mobile device 200 may be capable of communicating with the lockset 100, communicating with the server 18, communicating with other mobile devices, and communicating with the router 16. The mobile device 200 may have a mobile application installed thereon that is associated with the lockset 100 or the server 18. The mobile device 200 may include a web browser for accessing a program to communicate with the lockset 100 or the server 18. The mobile device 200 may include a camera and an application for analyzing images captured by the camera.

The router 16 may be a Wi-Fi router. In some embodiments, the router 16 may be located within the secured area or building to which the door 14 is attached. The router 16 may be capable of communicating with the lockset 100, and the router 16 may be capable of communicating with the server 18. The router 16 may route communications between the server 18 and the lockset 100. In some embodiments, the router may be a hub for Internet of Things (IoT) devices. In some embodiments, the lockset 100 and the router 16 may be coupled via a mesh network. For instance, communication between the lockset 100 and the router 16 may be passed through one or more other devices. In some implementations, the router 16 acts as a bridge between the lockset 100 and other portions of a home network, and may implement one or more functionalities of the lockset 100 (e.g., regarding communication with the mobile device 200 or other home network devices).

The server 18 can be, for example, a physical server or a virtual server hosted on a cloud platform 20. In examples, the cloud platform 20 may be a multi-cloud platform, a private cloud, a public cloud, or a hybrid cloud. In some embodiments, the server 18 may include a cluster of servers or nodes. In some embodiments, the lockset 100 is also capable of communicating with the server 18. Such communication can optionally occur via one or more wireless communication protocols, e.g., Wi-Fi (IEEE 802.11), short-range wireless communication to a Wi-Fi bridge, or other connection mechanism. According to an embodiment, the server 18 may create and store an account associated with one or more of the lockset 100, the user 12, the mobile device 200, the router 16, the door 14, or a building on which the door 14 is installed. In some embodiments, the server 18 may create or store credentials for one or more of the accounts.

FIG. 2 illustrates example configurations 30-40 of the door 14 and example premises 42-52 to which the door 14 may be attached. The premises 42-52 are examples of secured areas. The premises 42-52 may be, for example, a building, a fenced or otherwise enclosed area, a temporary structure, a geofenced area, or another geographical area. In the example of FIG. 2, a key 54 indicates that an inside of a premises of the premises 42-52 is marked using intersecting diagonal lines.

The inside of a premises may include an area that is enclosed by walls of a premises. Although not illustrated, an inside may include multiple levels (e.g., a basement, a first floor, and a second floor), and dimensions of each level may vary. In some embodiments, an inside of a premises may be defined using multiple areas, such as a building and an adjacent enclosed area, such as a garage, porch, or enclosed area. In some embodiments, the inside of a premises may only be partially defined (e.g., only walls nearby the door 14 may be considered). As is further indicated by the key 54, an outside of a premises of the premises 42-52 is marked by blank space. The outside of a premises of the premises 42-52 may include an area that is not part of the inside of a premises. In some embodiments, the outside may include an area in which a user may approach the door 14 from the outside. In some embodiments, an authentication zone associated with the lockset 100 may include an area that is outside of a premises and may not include an area that is inside of the premises.

As shown, in each of the example configurations 30-40, the dimensions of the respective premises of the premises 42-52 may vary. For example, in the configuration 30, a straight line may separate the inside of the premises 42 from the outside of the premises. In the example configuration 30, the lockset 100 attached to the door 14 may define an authentication zone that includes only an area outside of the premises 42 by using a 180-degree angle that extends outward from the lockset 100.

For the lockset 100 in the configurations 32-40, however, a different authentication zone may have to be determined, because a 180-degree angle that extends outward may include an area that is inside of the premises 42-52, which may, in some instances, cause the lockset 100 to actuate a locking mechanism without a user intending to do so. For example, referring to the example configuration 32, a user may be located inside of the premises 44 (e.g., in the part at the top of the premises 44 that extends outward), but if it is assumed that the inside and outside of the premises 44 may be separated by a single straight line (e.g., as is the case in the example configuration 30), then the lockset 100 may incorrectly determine that the user is outside of the premises 44. Similar issues may arise in connection with the example configurations 34-40.

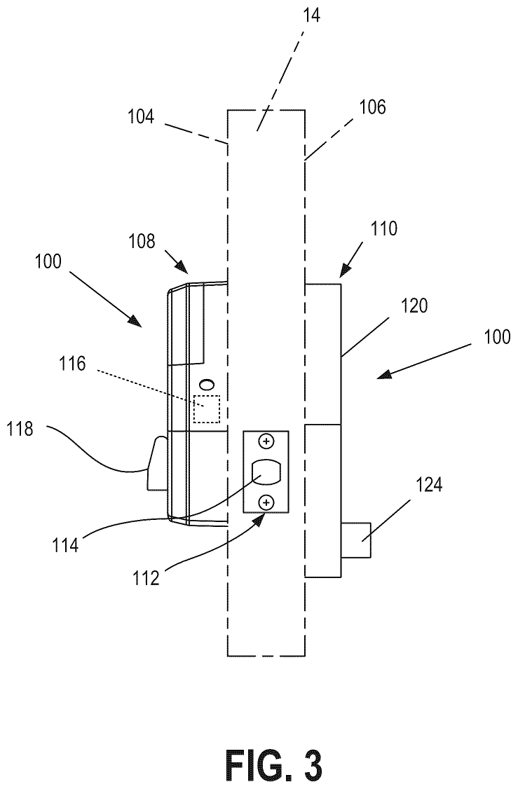

FIG. 3 illustrate a lockset 100 as installed at a door 14, according to one example of the present disclosure. The door 14 has an interior side 104 and an exterior side 106. The lockset 100 includes an interior assembly 108, an exterior assembly 110, and a latch assembly 112. To move the lockset 100 from a locked state to an unlocked state, or from an unlocked state to a locked state, the lockset 100 may actuate the latch assembly 112. The latch assembly 112 is shown to include a bolt 114 that is movable between an extended position (locked) and a retracted position (unlocked, shown in FIGS. 3-6). Specifically, the bolt 114 is configured to slide longitudinally and, when the bolt 114 is retracted, the door 14 is in an unlocked state. When the bolt 114 is extended, the bolt 114 protrudes from the door 14 into a doorjamb to place the door in a locked state. In examples, a processor of the lockset 100 may use a motor to actuate the bolt 114.

In some examples, the interior assembly 108 is mounted to the interior side 104 of the door 14, and the exterior assembly 110 is mounted to the exterior side 106 of the door 14. The latch assembly 112 is typically at least partially mounted in a bore formed in the door 14. The term outside is broadly used to mean an area outside the door 14, and the term inside is broadly used to denote an area inside the door 14, as described above in connection with FIG. 2. With an exterior entry door, for example, the exterior assembly 110 may be mounted outside a building, while the interior assembly 108 may be mounted inside a building. With an interior door, the exterior assembly 110 may be mounted inside a building, but outside a room secured by the lockset 100, and the interior assembly 108 may be mounted inside the secured room. The lockset 100 is applicable to both interior and exterior doors.

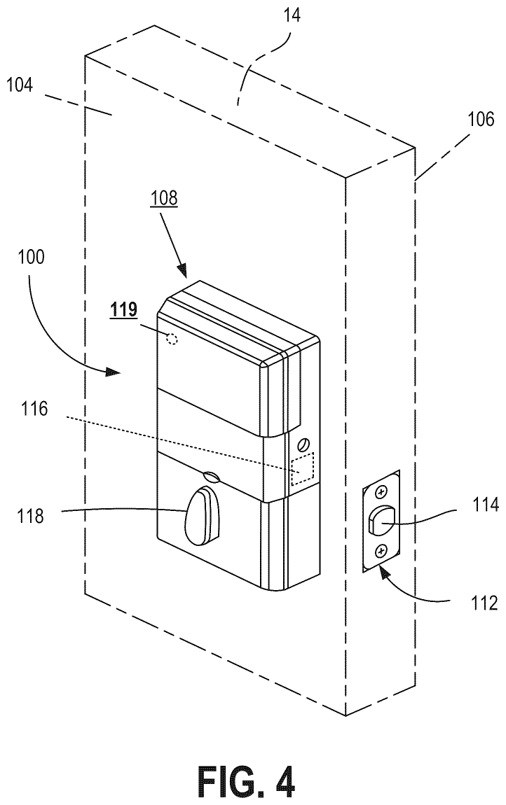

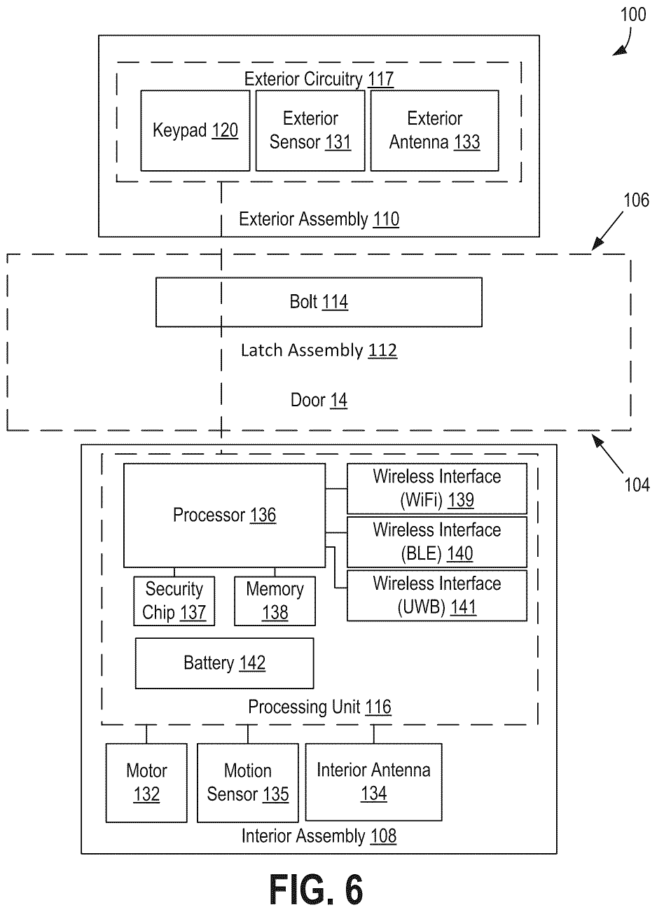

FIG. 4 illustrates a perspective view of the lockset 100 from an interior of the door 14. In some embodiments, the interior assembly 108 can include a processing unit 116 (shown schematically in FIG. 6) containing electronic circuitry for the lockset 100. In some examples, the interior assembly 108 includes a manual turn piece 118 that can be used on the interior side 104 of door 14 to move the bolt 114 between the extended and retracted positions. The processing unit 116 is operable to execute a plurality of software instructions (e.g., firmware) that, when executed by the processing unit 116, cause the lockset 100 to implement the methods and otherwise operate and have functionality as described herein. The processing unit 116 may comprise a device commonly referred to as a processor, e.g., a central processing unit (CPU), digital signal processor (DSP), or other similar device, and may be embodied as a standalone unit or as a device shared with components of the lockset 100. The processing unit 116 may include memory communicatively interfaced to the processor for storing the software instructions. Alternatively, the lockset 100 may further comprise a separate memory device for storing the software instructions that is electrically connected to the processing unit 116 for the bi-directional communication of the instructions, data, and signals therebetween.

In some examples, the interior assembly 108 includes a pairing button 119 (shown schematically), which when actuated, initiates a pairing mode for a connection over an interface. For example, the pairing mode may enable the lockset 100 to communicate with a mobile device (e.g., the mobile device 200) within wireless communication range for enabling the mobile device to be paired with the lockset 100. In some embodiments, once the lockset 100 is paired with the mobile device, the mobile device may be used as part of installing the lockset 100 or as part of determining an authentication zone associated with the lockset 100. In other embodiments, the mobile device 200 need not be paired with the lockset 100 to execute aspects of an installation process for the lockset 100. As can be appreciated, initiating the pairing mode via an actuation of the pairing button 119 may be limited to users who have access to the interior side 104 of the door 14. In some embodiments, the lockset 100 may be coupled with a mobile device without use of the pairing button 119. For instance, pairing may be performed by communicating with the server 18, or one or more of the mobile device 200 or the lockset 100 may broadcast a signal for pairing.

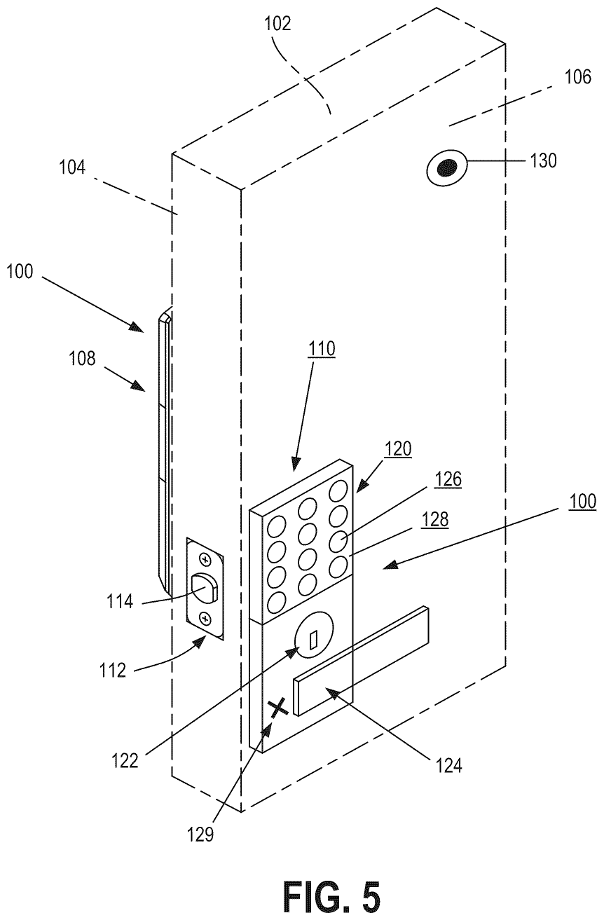

FIG. 5 illustrates a perspective view of the lockset 100 from an exterior of the door 14. The exterior assembly 110 can include exterior circuitry 117 communicatively and electrically connected to the processing unit 116. For example, the exterior assembly 110 can include a keypad 120 for receiving a user input and/or a keyway 122 for receiving a key. The exterior side 106 of the door 14 can also include a handle 124. In some examples, the exterior assembly 110 includes the keypad 120 and not the keyway 122. In some examples, the exterior assembly 110 includes the keyway 122 and not the keypad 120. In some examples, the exterior assembly 110 includes the keyway 122 and the keypad 120. In some examples, the exterior assembly 110 includes neither the keyway 122 nor the keypad 120. When a valid key is inserted into the keyway 122, the valid key can move the bolt 114 between the extended and retracted positions.

When a user inputs a valid actuation passcode into the keypad 120, the bolt 114 may be moved between the extended and retracted positions. In some examples, the exterior assembly 110 is electrically connected to the interior assembly 108. Specifically, in some examples, the keypad 120 may be electrically connected to the interior assembly 108, specifically to the processing unit 116, by, for example, an electrical cable (not shown) that passes through the door 14. When the user inputs a valid actuation passcode via the keypad 120 that is recognized by the processing unit 116, an electrical motor is energized to retract the bolt 114 of latch assembly 112, thus permitting door 14 to be opened from a closed position. In some embodiments, the lockset 100 may be wirelessly actuated without using the keypad 120. For example, the lockset 100 may wirelessly receive an actuation command from the user 12 or the mobile device 200. The actuation command may be accompanied by credentials that may be authenticated by the lockset 100 prior to locking or unlocking. In some embodiments, the lockset 100 may implement a plurality of authentication techniques. For example, the lockset 100 may require a code to be input at the keypad 120 and may require credentials authorizing a user from the mobile device 200. Still further, an electrical connection between the exterior assembly 110 and the interior assembly 108 allows the processing unit 116 to communicate with other features included in the exterior assembly 110, as noted below.

The keypad 120 can be any of a variety of different types of keypads. The keypad 120 can be one of a numeric keypad, an alpha keypad, and/or an alphanumeric keypad. The keypad 120 can have a plurality of characters displayed thereon. For example, the keypad 120 can include a plurality of buttons 126 that can be mechanically actuated by the user (e.g., physically pressed).

In some examples, the keypad 120 includes a touch interface 128, such as a touch screen or a touch keypad, for receiving a user input. The touch interface 128 is configured to detect a user's “press of a button” by contact without the need for pressure or mechanical actuation. In some embodiments, interacting with the keypad 120 may cause an electrical component of the lockset 100 to be activated (e.g., may cause a switch to close), which may allow the user to actuate the bolt 114 using the keypad 120.

In alternative embodiments, one or more other types of user interface devices can be incorporated into the lockset 100. For example, in example implementations, the exterior assembly 110 can include a biometric interface (e.g., a fingerprint sensor, retina scanner, or camera including facial recognition), or an audio interface by which voice recognition could be used to actuate the lock. Still further, other touch interfaces may be implemented, e.g., where a single touch may be used to actuate the lock rather than requiring entry of a specified actuation passcode.

In some embodiments, the lockset 100 may be coupled to a camera 130. In some embodiments, the camera 130 may be disposed on the exterior side 106 of the door 14. In some embodiments, the camera 130 may be activated by a processing unit of the lockset 100. In some embodiments, the camera 130 may detect movement (e.g., a user approaching the door 14). In response to detecting movement, the camera 130 may provide a signal to the lockset 100, thereby activating or deactivating a component of the lockset 100. In some embodiments, the camera 130 may determine or verify whether an authorized user is in an authentication zone associated with the lockset 100.

In some embodiments, indicia 129 may be displayed on the exterior assembly 110. The indicia 129 may be a mark that may be used by an image processing application to identify a location of the lockset 100. For example, an image processing application may be trained to recognize the indicia 129. Thus, when the image analysis program analyzes an image of the lockset 100, the program may recognize the indicia 129 and thereby recognize, in some embodiments, a location of the lockset 100 on the door 14. The indicia 129 may be any marking. In the example shown, the indicia 129 is an “X”. However, the indicia 129 may be a logo, a word, a color, a stamp, a barcode, a QR code, or another mark or feature on the lockset 100. In some embodiments (e.g., when the indicia 129 is a barcode, a QR code, or an alphanumeric string), the image processing application may determine an identifier associated with the lockset 100 by using the indicia 129. In some embodiments, the indicia 129 may be on the interior assembly 108 instead of or in addition to the exterior assembly 110. In some embodiments, the indicia 129 may be located on the door 14 or near the door 14 without being on the lockset 100. In some embodiments, an image processing application may determine a location of the lockset 100 by using other features of the lockset 100 instead of or in addition to the indicia 129.

FIG. 6 illustrates a schematic representation of an embodiment of the lockset 100 mounted to the door 14. Examples of the interior assembly 108, the exterior assembly 110, and the latch assembly 112 are shown. In other embodiments, the lockset 100 may include more or fewer components than those illustrated in connection with the FIG. 6. In some embodiments, the lockset 100 may include an electrical circuit that connects one or more components of the lockset 100 described herein. In examples, the electrical circuit may receive power from a battery 142 or from a different power source. In some embodiments, the lockset 100 may include a plurality of subcircuits, each of which may include one or more components of the lockset 100 described herein, and the subcircuits may, in some embodiments, allow the lockset 100 to selectively activate or deactivate only some electrical components.

The exterior assembly 110 is shown to include the keypad 120 and an exterior antenna 133 usable for communication with a remote device. In addition, the exterior assembly 110 can include one or more sensors 131, such as a camera, proximity sensor, button, or other mechanism by which conditions exterior to the door 14 can be sensed. In some embodiments, the exterior antenna 133 (or an interior antenna 134) may include a plurality of antennas that may be configured to detect a distance and direction of an object external to the lockset 100, such as a user. For example, the lockset 100 may implement angle-of-arrival or angle-of-departure techniques to determine a location of an external object relative to the lockset 100. In response to such sensed conditions (e.g., a detection of an object external to the lockset 100), notifications may be sent by the lockset 100 to a server 18 or mobile device 200, including information associated with a sensed event (e.g., time and description of the sensed event, or remote feed of sensor data obtained via the sensor).

As described above, the latch assembly 112 may include the bolt 114. To extend and retract the bolt 114, the latch assembly 112 may include a drive shaft that is operationally coupled with a motor 132 and the bolt 114. In some embodiments, the drive shaft may rotate in a first direction to extend the bolt and a second direction to retract the bolt.

As described above, the interior assembly 108 includes the processing unit 116. The interior assembly 108 can also include a motor 132, a motion sensor 135, and an interior antenna 134. As shown, the processing unit 116 includes at least one processor 136 communicatively connected to a security chip 137, a memory 138, various wireless network interfaces, and a battery 142. For example, the processing unit 116 may include a network interface for communicating via the IEEE 802.11 standard (Wi-Fi®), the IEEE 802.15.4 standard (Zigbee®, Z-Wave®, and Thread), the IEEE 802.15.1 standard (Bluetooth®), or another standard. In some embodiments the Bluetooth interface 140 may be configured to communicate via a Bluetooth Low Energy (BLE) protocol. In some embodiments, the UWB interface 141 may be configured via a UWB protocol. In some embodiments, a network interface for communicating via other communication protocols may be present, either instead of, or in addition to, the Wi-Fi interface 139, the BLE interface 140, and the UWB interface 141. For example, the electronic lockset 100 may include a network interface for communicating according to one or more of the following protocols: Thread, Matter, near-field communication (NFC), Z-Wave, ZigBee, Narrow Band IoT (NB-IoT), LoRa, 3G, LTE, 4G, 5G or another protocol or network. The processing unit 116 is located within the interior assembly 108 and is capable of operating the lockset 100, e.g., by actuating the motor 132 to actuate the bolt 114.

In some examples, the processor 136 can process signals received from a variety of devices to determine whether the lockset 100 should be actuated. Such processing can be based on a set of preprogramed instructions (i.e., firmware) stored in the memory 138. In certain embodiments, the processing unit 116 can include a plurality of processors 144, including one or more general purpose or specific purpose instruction processors. In some examples, the processing unit 116 is configured to capture a keypad input event from a user and store the keypad input event in the memory 138. In other examples, the processor 136 receives a signal from the exterior antenna 133, the interior antenna 134, or a motion sensor 135 (e.g., a vibration sensor, gyroscope, accelerometer, motion/position sensor, or combination thereof) and can validate received signals in order to actuate the lockset 100. Furthermore, in some examples, the processor 136 may determine whether a location from which the received signals were sent, and the processor 136 may determine whether this location is in an authentication zone prior to actuating the lockset 100. The processor 136 may similarly determine a location of a computing device associated with a user of the lockset 100 and automatically actuate the lockset 100 when the processor 136 determines that the computing device is within the authentication zone. In still other examples, the processor 136 receives signals from one or more network interfaces to determine whether to actuate the lockset 100.

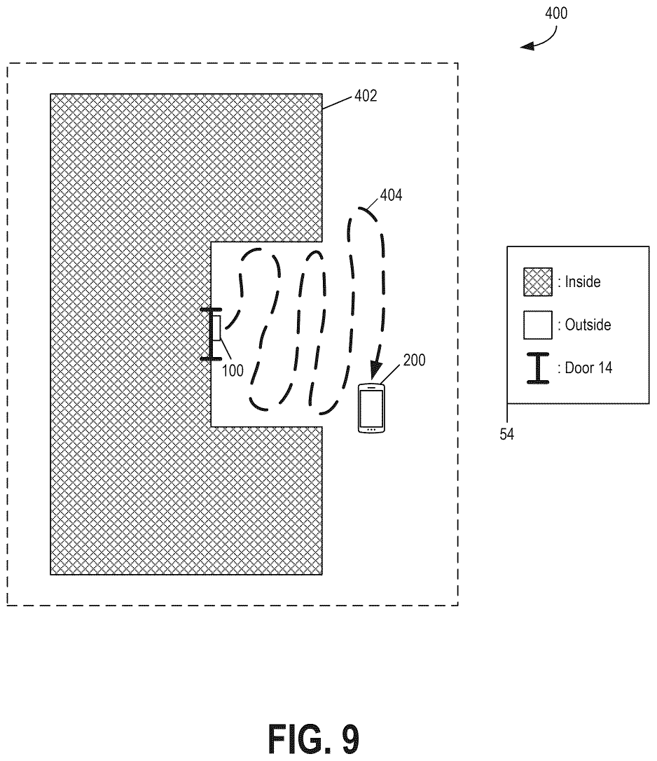

In some embodiments, the processing unit 116 may be configured to execute instructions to define an authentication zone. Example operations for defining an authentication zone are described below in connection with FIGS. 9-16. In some embodiments, the processing unit 116 may determine an authentication zone associated with the lockset 100 based at least in part on data captured by an external computing device, such as a user's smartphone. For example, the lockset 100 may enter a ranging communication with the computing device, such as by using the UWB interface 141 to determine positions of the computing device relative to the lockset 100. Sensor data captured by the computing device, or other additional data, may additionally or alternatively be used to determine the authentication zone, as described further herein. Based on such data, the processing unit 116 may determine an authentication zone. In alternative embodiments, an external server, such as the server 18 described above in connection with FIG. 1, may define the authentication zone and transmit the defined authentication zone to the lockset 100. The lockset 100 may store the defined authentication zone in the memory 138.

In some embodiments, the processing unit 116 includes a security chip 137 that is communicatively interconnected with one or more instances of processor 136. The security chip 137 can, for example, generate and store cryptographic information usable to generate a certificate usable to validate the lockset 100 with a remote system, such as the server 18 or mobile device (e.g., the mobile device 200). In certain embodiments, the security chip 137 includes a one-time write function in which a portion of memory of the security chip 137 can be written only once, and then locked. Such memory can be used, for example, to store cryptographic information derived from characteristics of the lockset 100, or its communication channels with server 18 or one or more mobile devices 200. Accordingly, once written, such cryptographic information can be used in a certificate generation process which ensures that, if any of the characteristics reflected in the cryptographic information are changed, the certificate that is generated by the security chip 137 would become invalid, and thereby render the lockset 100 unable to perform various functions, such as communicate with the server 18 or mobile device 200, or operate at all, in some cases.

In some embodiments, the security chip 137 may be configured to generate a pairing passcode that, when entered using the keypad 120 of the lockset 100, triggers a pairing mode of one or more of the network interfaces of the lockset 100 that enables the lockset 100 to pair with a proximate mobile device. In some embodiments, a pairing passcode may be used to pair with a proximate mobile device. In some examples, the pairing passcode is provided to the user 12 upon initial setup/activation of the lockset 100 (e.g., via an electronic lock application associated with the lockset 100 operating on the mobile device 200). In some examples, the pairing passcode is a random value. In some examples, the user 12 may be enabled to change the pairing passcode by setting their own code or by requesting a random value to be generated by the electronic lock application operating on the mobile device 200. In some examples, the length of the pairing passcode is variable. According to an aspect, for increased security, the pairing passcode may be a limited-use passcode. For example, the pairing passcode may be limited to a single use or may be active for a preset or administrative user-selected time duration. In further examples, a digit of the pairing passcode may correspond to a setting that may instruct the lockset 100 to perform one or more of: disable the pairing passcode after it has been used; keep the pairing passcode enabled after it has been used; or reset the pairing passcode to a new random value after it has been used.

The memory 138 can include any of a variety of memory devices, such as using various types of computer-readable or computer storage media. A computer storage medium or computer-readable medium may be any medium that can store a program or instructions for performing one or more operations, steps, or methods described herein. By way of example, computer storage media may include dynamic random access memory (DRAM) or variants thereof, solid state memory, read-only memory (ROM), electrically erasable programmable ROM, and other types of devices and/or articles of manufacture that store data. Computer storage media generally includes at least one or more tangible media or devices.

Computer storage media can, in some examples, include embodiments including entirely non-transitory components. In some embodiments, the processor 136 may execute programs or instructions stored by the memory 138. In some embodiments, the memory 138 may store one or more codes that may be input by a user to actuate the bolt 114. For instance, a user may input a code into the keypad 120, or the mobile device 200 may provide a code to the lockset 100 via a network interface. To validate the code, the processor 136 may compare the input code to the one or more codes stored in the memory 138. In some embodiments, the memory 138 may store data that indicates a handing of the door 14, or the memory 138 may store data that indicates that the handing for the door 14 has not yet been determined. In some embodiments, the processor 136 may use the data indicating a handing of the door 14 as part of actuating the motor 132 to control movement of the bolt 114.

As noted above, the processing unit 116 can include one or more wireless interfaces, such as Wi-Fi interface 139, a Bluetooth interface 140, a UWB interface 141, and/or another interface. Other RF circuits can be included as well. In the example shown, the interfaces 139, 140, and 141 are capable of communication using at least one wireless communication protocol. In some examples, the processing unit 116 can communicate with a remote device, such as the server 18, via a first network interface (e.g., the Wi-Fi interface 139) and with a proximate device, such as the mobile device 200, via a second network interface (e.g., the interface 140 or the interface 141). In some embodiments, the processing unit 116 is configured to communicate with the mobile device 200 via a short-range wireless interface, such as a network interface configured to communicate using a protocol for any one or more of BLE, NFC, UWB, Thread, or another protocol. When the mobile device 200 is out of range of such a network, the mobile device 200 may communicate with the server 18, which may relay communications to the lockset 100. In some embodiments, the lockset 100 may use the Wi-Fi interface 139 to communicate with the server 18. In other embodiments, the lockset 100 may communicate with a hub device or router device using a different network protocol (e.g., BLE, NFC, Thread), and the hub device or router may route communications between the server 18 and the lockset 100.

The interior assembly 108 also includes the battery 142 to power the lockset 100. In some embodiments, the lockset 100 may include a plurality of batteries, or the lockset 100 may also include other power sources. In one example, the battery 142 may be a standard single-use (disposable) battery.

The interior assembly 108 also includes the motor 132 that is capable of actuating the bolt 114. In use, the motor 132 receives an actuation command from the processing unit 116, which causes the motor 132 to actuate the bolt 114 from the locked position to the unlocked position or from the unlocked position to the locked position. In some examples, the motor 132 actuates the bolt 114 to an opposing state. In some examples, the motor 132 receives a specified lock or unlock command, where the motor 132 only actuates the bolt 114 if the bolt 114 is in the correct position. For example, if the door 14 is locked and the motor 132 receives a lock command, then no action is taken. If the door 14 is locked and the motor 132 receives an unlock command, then the motor 132 actuates the bolt 114 to unlock the door 14. In some embodiments, the processing unit 116 will actuate the motor 132 in response to wirelessly receiving user credentials and an instruction to actuate the bolt 114. In some embodiments, the processing unit 116 may determine whether a source of the wireless credentials is located in an authentication zone prior to actuating the motor 132. In some embodiments, the operation of the motor 132 to actuate the bolt 114 may depend at least in part on the handing of the door 14. In some embodiments, a mechanism other than the motor 132 may be used to electrically actuate the bolt 114, such as magnets or solenoids.

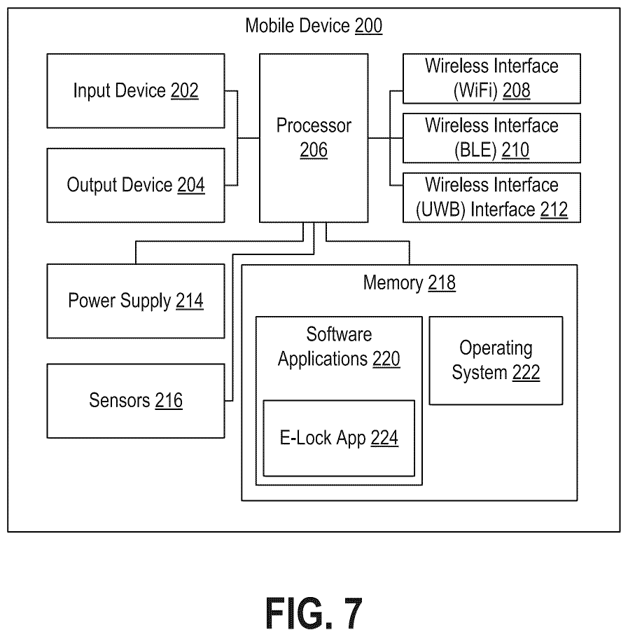

FIG. 7 illustrates a schematic diagram of a mobile device, such as the mobile device 200, usable in embodiments of the present disclosure. In some embodiments, the mobile device 200 operates to form a connection with a network-enabled security device such as the lockset 100. In some embodiments, the mobile device 200 may communicate with the server 18 via a Wi-Fi or mobile data connection. Thus, in some embodiments, the mobile device 200 can operate to communicate information between the lockset 100 and the server 18. The mobile device 200 shown in FIG. 7 includes an input device 202, an output device 204, a processor 206, a Wi-Fi interface 208, a BLE interface 210, a UWB interface 212, a power supply 214, one or more sensors 216, and a memory 218. In some embodiments, the mobile device 200 may include more or fewer network interfaces. In some embodiments, the mobile device 200 may include an interface to communicate via a cellular network, a Thread protocol, near-field communication protocol, or another protocol or network type.

The input device 202 operates to receive input from external sources. Such sources can include inputs received from a user (e.g., the user 12). The inputs can be received through a touchscreen, a stylus, or keyboard. In some embodiments, the input device may be a microphone, and the mobile device 200 may receive a voice input. In some embodiments, the input device is a camera, and the mobile device may receive an image input or a video input via the camera.

The output device 204 operates to provide output of information from the mobile device 200. For example, a display can output visual information while a speaker can output audio information.

The processor 206 reads data and instructions. The data and instructions can be stored locally, received from an external source, or accessed from removable media. In some examples, the Wi-Fi interface 208 is similar to the Wi-Fi interface 139. In some embodiments, a Wi-Fi connection may be established between the mobile deice 200 and the server 18. In some embodiments, a connection via a cellular network may be established between the mobile device 200 and the server 18. In some embodiments, the BLE interface 210 is similar to the Bluetooth interface 140. In some examples, a Bluetooth connection may be established between the mobile device 200 and the lockset 100. In some embodiments, the UWB interface 212 is similar to the UWB interface 141. In some examples, a UWB connection may be established between the mobile device 200 and the lockset 100. In some embodiments, a connection according to an NFC protocol, Thread protocol, or other protocol may be established between the mobile device 200 and the lockset 100.

The power supply 214 provides power to the processor 206. The sensors 216 may include one or more sensors for collecting data associated with the mobile device 200. For example, the sensors may include an inertial measurement unit, a GPS receiver, a temperature sensor, and a light sensor. In alternative examples, the mobile device 200 may include additional or alternative sensors, including other environmental sensors. As described further herein, data collected by the sensors 216 may be used to define a boundary map and an authentication zone.

The memory 218 includes software applications 220 and an operating system 222. The memory 218 contains data and instructions that are usable by the processor to implement various functions of the mobile device 200. Furthermore, the memory 218 may store credentials (e.g., a code or other alphanumeric data) that is associated with the user 12 or the mobile device 200. The mobile device 200 may provide the credentials to the lockset 100 in response to a user input or in response to receiving a communication from the lockset 100. In some embodiments, the mobile device 200 may automatically provide the credentials to the lockset 100 in response to entering a communication range of the lockset 100 (e.g., in response to being within range to communicate with the lockset 100 over BLE or UWB).

The software applications 220 can include applications usable to perform various functions on the mobile device 200. One such application is an electronic lock application 224. In some embodiments, the electronic lock application 224 may be used to interact with the lockset 100. In some embodiments, the electronic lock application 224 may be used to interact with the server 18. In some embodiments, the electronic lock application 224 may be used as part of installing the lockset 100. In some embodiments, the electronic lock application 224 may be used to determine an authentication zone associated with the lockset 100. In other embodiments, the mobile device 200 may include more or fewer components than those illustrated in the example of FIG. 7.

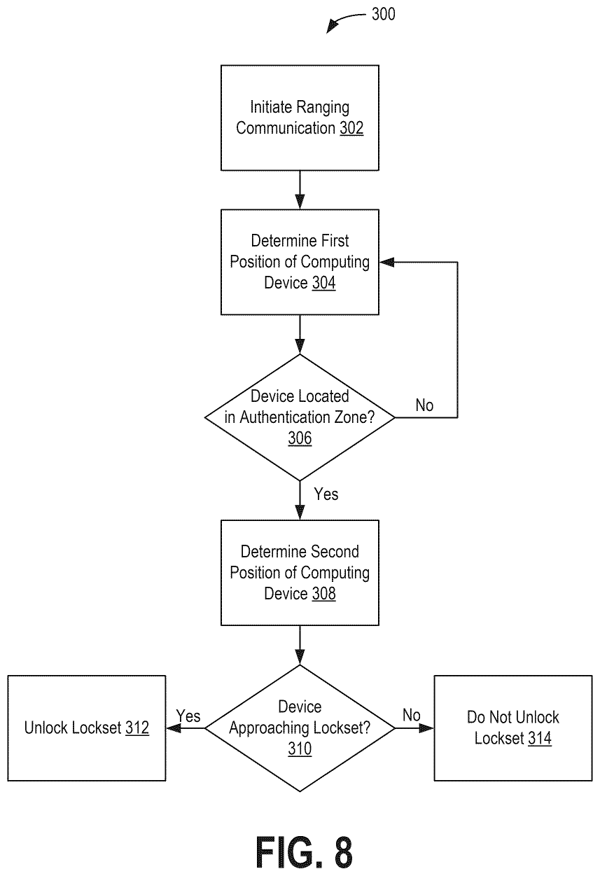

FIG. 8 is a flowchart of an example method 300 for determining whether to actuate a lock. In example embodiments, operations of the method 300 are performed by the lockset 100. However, one or more operations of the method 300 may be performed by one or more other components, such as the server 18 or the mobile device 200. In some example embodiments, portions of the method 300 may be performed by the lockset 10, while other portions may be performed by another device, such as a bridge device that is positioned within wireless range of the lockset and which incorporates some or all of the functionality of the lockset (e.g., including UWB-based communication or ranging). The bridge device may be positioned at a location at which it has access to a power source (e.g., a wall outlet or the like) and may perform higher-power operations on behalf of the lockset 100. In the illustrated embodiment, the method 300 includes operations 302, 304, 306, 308, 310, 312, 314.

The operation 302 includes initiating a ranging communication between a lockset and a computing device, such as a user's mobile device. In an example, the ranging communication may include a UWB communication. In some examples, the lockset may act as the UWB transmitter, and the computing device may act as the UWB receiver. In alternative examples, the lockset may act as the UWB receiver, and the computing device may act as the UWB transmitter. In alternative embodiments, the ranging communication may include any secure communication.

The operation 304 includes determining a first position of the computing device. For example, the first position may be a position of the computing device relative to the lockset. In embodiments, the first position of the computing device may be determined using the ranging communication between the computing device and the lockset. For example, time difference of arrival or two-way ranging may be used to determine the position of the computing device relative to the lockset using the ranging communication. In alternative examples, sensor data collected by the computing device may be transmitted to the lockset, and the lockset may use the sensor data to determine a position of the computing device relative to the lockset. Examples of sensor data that may be captured by the computing device and transmitted to the lockset include GPS data, inertial measurement unit data, temperature data, and ambient light data. In further examples, additional or alternative sensor data may be captured by the computing device.

The operation 306 includes determining whether the computing device is located within an authentication zone. The authentication zone, as described above, may define an area from which the electronic lockset is wirelessly actuatable. In examples, the authentication zone is defined in a boundary map that defines the interior and exterior of a premises. In some embodiments, the lockset may store a definition of the authentication zone and determine if the first position of the computing device is located within the authentication zone. In alternative embodiments, the computing device may store a definition of the authentication zone and determine if the first position of the computing device is located within the authentication zone.

In some examples, if the first position of the computing device is determined to be within the authentication zone, the lockset may actuate to lock or unlock a door. Conversely, if the first position of the computing device is not within the authentication zone, the lockset may not actuate. In such cases, additional positions of the computing device may be determined until the computing device is determined to be within the authentication zone.

In the illustrated embodiment, the method 300 includes additional operations that may be performed to determine an intent of the user before actuating the lockset. In the illustrated example, if the computing device is determined to be within the authentication zone during the operation 306, the method 300 may proceed to the operation 308 in which a second position of the computing device is determined. Like with first position, the second position of the computing device may be determined using the ranging communication.

The operation 310 includes determining whether the computing device is approaching the lockset. In an example, the second position of the computing device is compared to the first position of the computing device. If the second position of the computing device is closer to the lockset than the first position of the computing device, the computing device may be determined to be approaching the lockset. While the illustrated example describes using two positions of the computing device to determine an intent of the user (e.g., whether the computing device is approaching the lockset), in alternative embodiments, additional positions of the computing device may be determined and used to determine the intent of the user.

If the computing device is approaching the lockset, the method 300 may proceed to the operation 312. The operation 312 includes unlocking the lockset. In an example, the lockset may determine the first and second positions of the computing device and subsequently perform an unlock operation when the computing device is located within the authentication zone and is approaching the lockset. In some embodiments, additional authentication of the user may be required before unlocking the lockset during the operation 312. For example, in an embodiment, the computing device may transmit credentials to the lockset, and the lockset may unlock if the computing device is located within the authentication zone, the computing device is approaching the lockset, and the credentials are authenticated. Other authentications techniques may additionally or alternatively be used by the lockset to authenticate the user prior to unlocking the lockset during the operation 312.

Similarly, in some examples, the computing device may determine the first and second positions and subsequently transmit credentials and an unlock command to the lockset when the computing device determines that it is located in the authentication zone and is approaching the lockset. Conversely, if the computing device is not approaching the lockset, the method 300 may proceed from the operation 310 to the operation 314, and the lockset is not unlocked.

While the illustrated example describes unlocking the lockset when the computing device is approaching the lockset, the method 300 may similarly be performed to lock the lockset. For example, if the computing device is determined to be within the authentication zone at the operation 306 and moving away from the lockset at the operation 310, the lockset may perform a lock operation.

In further examples, one or more of the lockset operations may be performed by a bridge device placed at a known location relative to the lockset and may be utilized as a UWB transmitter and/or receiver in place of the lockset. For example, ranging and location of a mobile device relative to the lockset may be performed by a bridge device which determines the relative position of the mobile device to the bridge device, and either the bridge device or lockset may then calculate the relative position of the mobile device to the lockset based on a known spatial relationship between the lockset and bridge.

Referring now to FIGS. 9-16, systems and methods for defining an authentication zone is provided. As described herein, an authentication zone may be defined during an initial setup of a lockset. Additionally or alternatively, the authentication zone may be defined or updated over time through use of the lockset. In embodiments, sensor data captured by a computing device may be used to define the authentication zone. In additional embodiments, ranging data captured during a ranging communication between the computing device and the lockset may additionally be used. In further embodiments, other data may additionally or alternatively be used to determine the authentication zone.

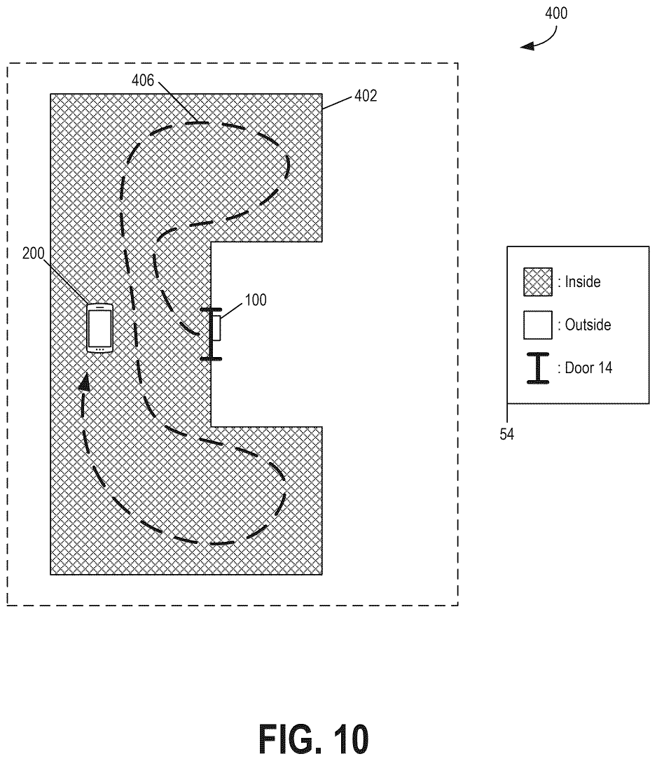

FIGS. 9 and 10 illustrate examples of a user configuring an authentication zone. In the illustrated examples, a user may maneuver a computing device 200 around an environment 400 that includes a premises 402 with a lockset 100 associated with a door 14. As the user maneuvers the computing device 200 around the environment, data may be collected that is used to create a boundary map that defines the interior and exterior of the premises 402. Using the interior/exterior boundaries defined in the boundary map, the authentication zone can be defined.

FIG. 9 illustrates a user traversing a path 404 in an area outside of premises 402. While the illustrated example shows the user walking the path 404 around a portion of the exterior of the premises 402, in alternative embodiments, the user may walk around the entire exterior premises 402. In embodiments, as the user traverses the path 404 in the area outside of the premises 402, the computing device 200 collects data associated with the movement of the user. For example, the computing device 200 may include an inertial measurement unit (IMU) that collects data regarding the user's acceleration, rotation, and velocity. Using this data, the computing device 200 may determine where the user has walked relative to the lockset 100. For example, if the starting position of the user is known (e.g., at the lockset 100), then the IMU data that is collected as the user walks around the exterior of the premises 402 can be used to determine what is exterior to the premises 402, and a boundary map can be defined accordingly. In another example, the user may identify an alternative starting position. Similarly, as the user walks the path 404, the user may indicate one or more points along that path 404 to define the authentication zone within the boundary map.

In other embodiments, additional or alternative data may be collected by sensors on the computing device 200. For example, in an embodiment, the computing device 200 may capture GPS data as the user walks around. Like with the IMU data, GPS data captured by the computing device 200 may be used to determine what is exterior to the premises 402 as the user traverses the path 404 outside of the premises 402. In another example, satellite imagery of the premises 402 may be analyzed to define the boundary map for the premises 402.

Positioning data collected from a ranging communication between the lockset 100 and the computing device 200 may additionally or alternatively be used to define the boundary map. In examples, like with the IMU data, ranging data can be used to determine a position of the computing device 200 relative to the lockset 100 as the user traverses the path 404. In examples, during a setup process, the user may indicate that the path 404 is exterior to the premises 402, so the area traversed by the user can be defined as exterior on the boundary map.

In another example, images captured by the computing device 200 may be used to generate the boundary map. For example, at one or more points along the path 404, the user may capture an image of the premises 402 using the computing device 200. The images captured by the computing device 200 may be analyzed to determine a blueprint of the premises 402 and accordingly define a boundary map. In an embodiment, the images may be analyzed together with other data, such as the positioning data collected during the ranging communication between the lockset 100 and the computing device 200 or the IMU data. In an example, the positioning data may be used to determine a location at which an image was captured, and the image may be analyzed to determine positions of walls or other structures of the premises 402 within the image. By combining the position at which the image was captured with the positions of the structures in the image, the positions of the structures relative to the lockset 100 can be determined. In another data, the image may be captured with depth data (e.g., data captured by a LiDAR sensor in the computing device 200), and the depth data may be used to determine the positions of the structures within the image.

Similarly, the computing device 200 may execute augmented reality software configured to capture data about the premises 402. Like with the captured images described above, the augmented reality software may capture views of the premises 402 and estimate distances and other measurements associated with the premises 402. In some examples, the user may select areas within the augmented reality software to be defined within the boundary map. For example, the user may indicate which areas of the premises 402 are interior or exterior. The data collected by the augmented reality software may be processed to generate the boundary map.

In example embodiments, the captured data (e.g., the IMU data, the GPS data, the satellite images, positioning data, and the captured images) or a subset thereof may be analyzed by a localization algorithm to generate the boundary map. In an embodiment, the localization algorithm may include a Simultaneous Localization and Mapping algorithm. In another embodiment, the localization algorithm may include an Adaptive Monte Carlo Localization algorithm.

While FIG. 9 shows an example of data collection as a user walks a path 404 outside of the premises, in alternative examples, as shown in FIG. 10, data may additionally or alternatively be captured as the user walks a path 406 inside of the premises 402. By capturing data (e.g., IMU data, GPS data, positioning data, and captured images) as the user traverses the path 406 inside of the premises, the interior of the premises 402 can be identified similarly to how the exterior of the premises 402 is identified when the user walks the path 404 outside of the premises 402.

In further examples, the user may walk a path that traverses both the exterior of the premises 402 and the interior of the premises 402. For example, as the user traverses the path through the interior and the exterior of the premises 402, the user may indicate when the user transitions from being outside of the premises 402 to being inside of the premises 402.

In embodiments, the boundary map is generated by a server, such as the server 18 described above in connection with FIG. 1. For example, the data that is captured as the user walks the path 404 and the path 406 may be transmitted from the lockset 100 or the computing device 200 to the server for processing. The server may generate the boundary map (e.g., by inputting the data into a localization algorithm) and transmit the boundary may to the lockset 100 or the computing device 200. The server may similarly define the authentication zone within the boundary map. In alternative embodiments, the lockset 100 or the computing device 200 may process the captured data to generate the boundary map and define the authentication zone. The lockset 100 and computing device 200 may transmit the boundary map and authentication zone information to other devices as appropriate.

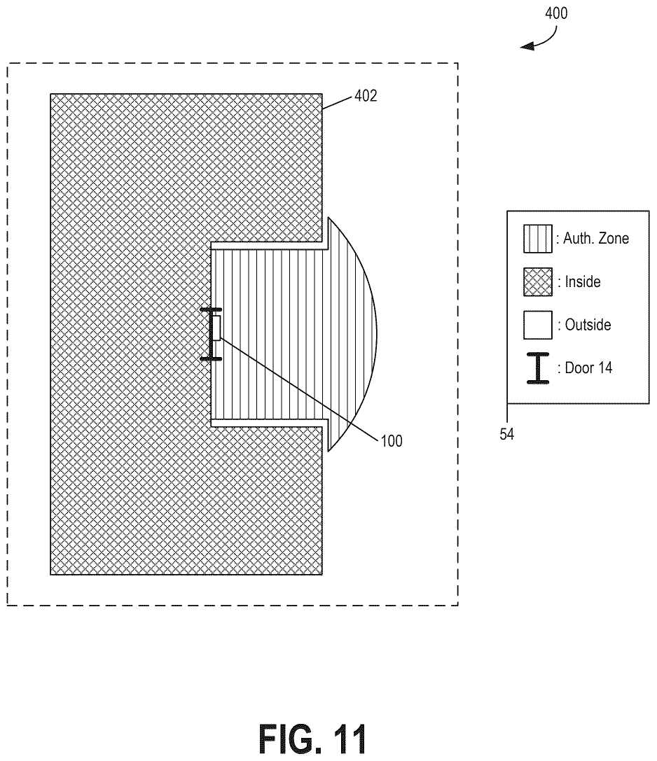

The authentication zone may be defined in the boundary map. For example, the authentication zone may be defined as an area exterior to the premises 402 within a ten-foot radius from the lockset 100. Because the boundary map defines the interior and exterior portions of the premises and the location of the lockset 100, the authentication zone can be defined in the boundary map. In other examples, the user may interact with the boundary map to define an authentication zone. For example, a user interface presented on the computing device 200 may allow the user to draw an authentication zone on the boundary map. Other examples for defining an authentication zone are described in co-pending U.S. Provisional Patent Application No. 63/635,860, entitled “System for Determining an Authentication Zone for an Electronic Lockset”, the disclosure of which is hereby incorporated by reference in its entirety. FIG. 11 illustrates an example of an authentication zone defined in the environment 400.

Although the examples described above describe capturing data during a setup process of the lockset 100 to define a boundary map and an authentication zone, in alternative embodiments, the boundary map may be generated based on data captured outside of the setup process. For example, data may be collected passively as the user uses the lockset 100, and this captured data may be used to automatically generate or refine a boundary map.

Similar data as described above (e.g., IMU data, GPS data, and positioning data) may be captured passively as the user uses the lockset 100 and used to generate the boundary map. Because the data is collected outside of the setup process, the user may not define before the data is captured whether the computing device 200 is located inside or outside the premises 402. In these examples, additional data may be collected and used to infer whether the computing device 200 is inside or outside.

In an example, a temperature sensor in the computing device 200 may be used to determine an ambient temperature when the other data (i.e., the IMU data, GPS data, or positioning data) is collected. The ambient temperature may be used determine whether the computing device 200 is inside or outside. For example, if the ambient temperature is sufficiently high (e.g., above 78° F.) or sufficiently low (e.g., below 62° F.), it may be inferred that the phone is not in a temperature-controlled environment and is therefore outside. In other examples, other environmental sensors in the computing device 200, such as an ambient light sensor, may collect data that is used to infer whether the computing device 200 is inside or outside.

Whether the computing device 200 is inside or outside may additionally or alternatively be inferred based on use of the lockset 100. For example, if lockset 100 is unlocked, such as by an unlock command transmitted to lockset 100 from the computing device 200, it may be inferred that the user (and therefore the computing device 200) is entering the premises 402 and will be inside and subsequently captured data may be used to define the interior of the premises 402. Similarly, it may be inferred that the user was outside of the premises 402 before transmitting the unlock command, so data collected prior to transmitting the unlock command may be used to define the exterior of the premises 402. Conversely, in an embodiment, if the lockset 100 is locked, such as by a lock command transmitted to the lockset 100 from the computing device 200, it may be inferred that the user (and therefore the computing device 200) is exiting the premises 402 and will be outside, so previously captured data may be used to define interior of the premises 402 and subsequently captured data may be used to define the exterior of the premises 402.

In some embodiments, the data may be captured one time and used to generate the boundary map. In alternative embodiments, the data may be captured over multiple data collection processes. In these embodiments, the data may be analyzed to detect patterns—e.g., to determine if the user approaches the lockset 100 along a similar trajectory each time—and the patterns may be used in the generation of the boundary map and the authentication zone. In some examples, the detected patterns may be used during authentication processes. For example, the lockset 100 may be configured to unlock when the user is within the authentication zone and the user is approaching the lockset 100 along a similar trajectory as was detected during the capture of sensor data. Conversely, the lockset 100 may be configured to lock when the user is within the authentication zone and is moving away from the lockset 100 along a similar trajectory as was detected during the capture of sensor data.

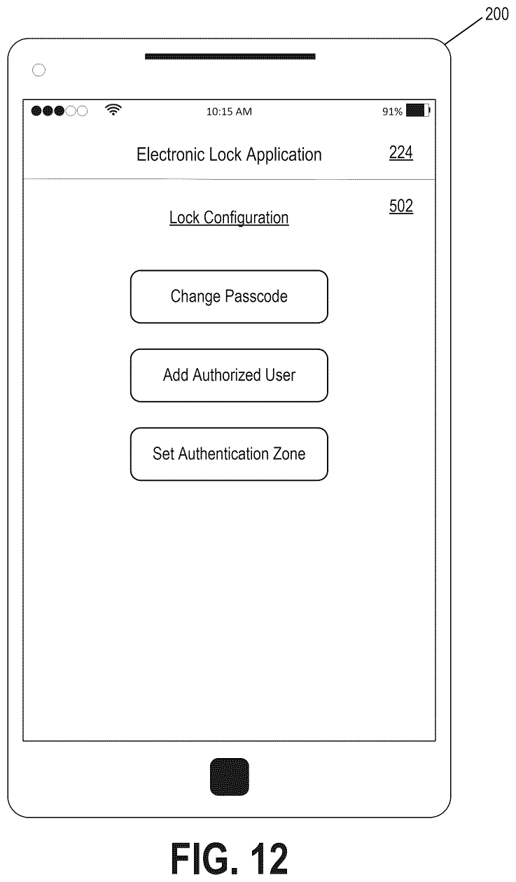

FIGS. 12-15 illustrate example user interfaces of an electronic lock application 224 for configuring an authentication zone. In example embodiments, the electronic lock application 224 may operate on a computing device 200, such as a smartphone.

FIG. 12 illustrates a lock configuration user interface 502. In the illustrated example, the lock configuration user interface 502 may include options for a user to configure settings of an associated lockset. For example, the options may include options to change a passcode for the lockset or add an authorized user. The options may additionally include an option to set or modify an authentication zone for the lockset. As described above, the authentication zone may define an area from which the electronic lockset is wirelessly actuatable.

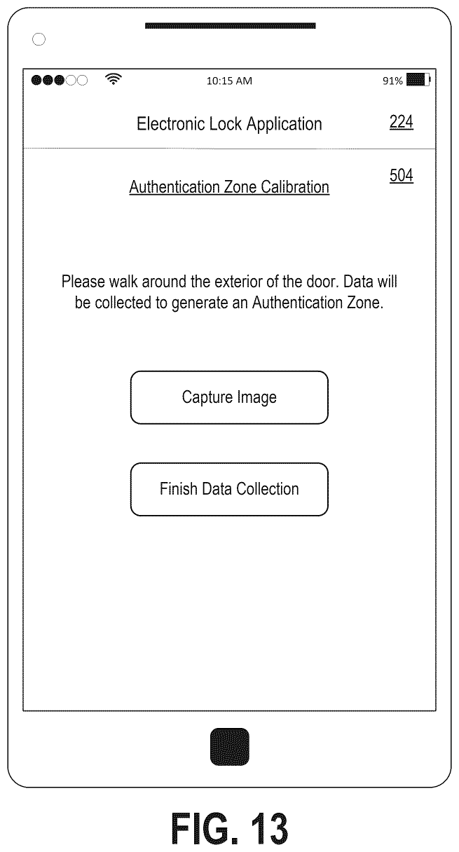

If the user selects to set or modify an authentication zone, the electronic lock application 224 may present an authentication zone calibration user interface 504, shown in FIG. 13. In the illustrated example, the authentication zone calibration user interface 504 includes instructions for the user explaining how do calibrate the authentication zone. For example, the instructions may instruct the user to walk around an exterior side of a door at which the lockset is installed. As explained above, data may be collected as the user walks around outside of the door, and the collected data may be used to generate a boundary map in which the authentication zone is defined. In some examples, the authentication zone calibration user interface 504 may include an option for the user to capture one or more images of the premises. The authentication zone calibration user interface 504 may additionally include an option for the user to end the data collection process.

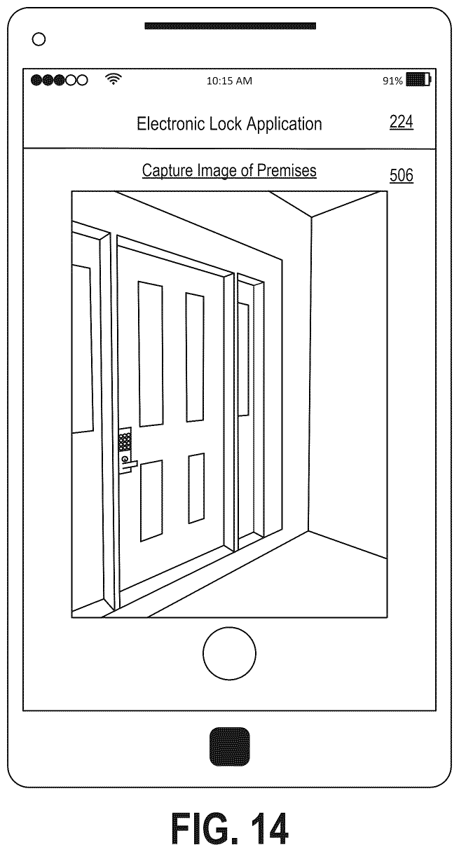

FIG. 14 illustrates an example image capture user interface 506. As described above, in some embodiments, images of the premises may be used in the generation of the boundary map. In the illustrated example, the image capture user interface 506 includes an image preview presenting what is seen by the camera and an option to capture an image.

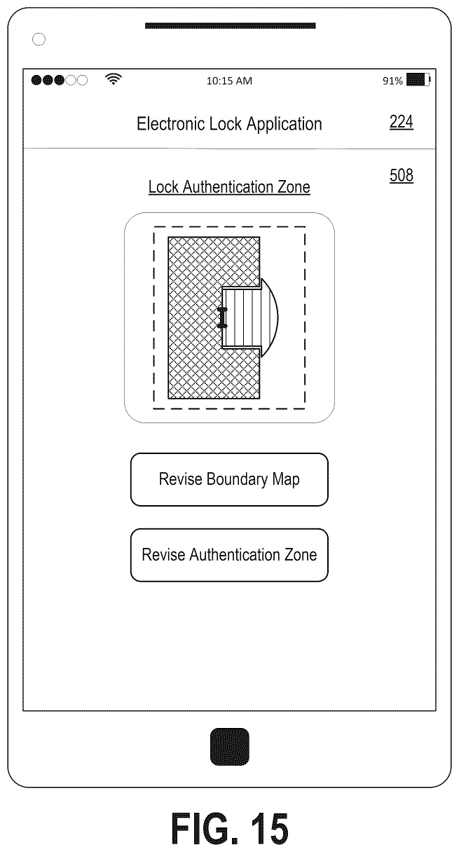

FIG. 15 illustrates an authentication zone user interface 508. In the illustrated embodiment, the authentication zone user interface 508 includes a preview of the boundary map and the authentication zone. The authentication zone user interface 508 also includes options for the user to revise the boundary map and revise the authentication zone. The boundary map and authentication zone may be revised using any of the processes described herein. Alternatively, in some embodiments, the boundary map or the authentication zone may be revised by the user drawing on the authentication zone user interface 508 to modify the boundary map or the authentication zone.

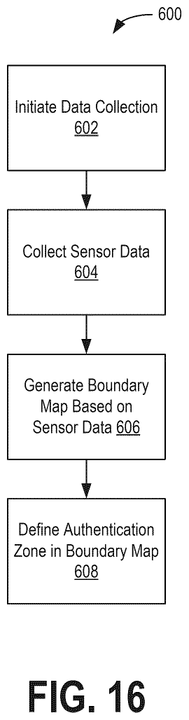

FIG. 16 illustrates a flowchart of an example method 600 for defining an authentication zone. In embodiments, operations of the method 600 may be performed by a computing device. However, one or more operations of the method 300 may be performed by one or more other components, such as the server 18 described above in connection with FIG. 1. In the illustrated embodiment, the method 600 includes operations 602, 604, 606, 608.

The operation 602 includes initiating data collection. In an example, data collection is initiated during a setup process of a lockset. In alternative examples, data collection may occur based on use of the electronic lockset. For example, data collection may be initiated after locking or unlocking the electronic lockset. In embodiments, a computing device initiate data collection.

The operation 604 includes collecting sensor data. In examples described above, the sensor data collected may include one or more of IMU data, GPS data, positioning data, and captured images. In alternative embodiments, additional or alternative sensor data may be captured. In some examples, the sensor data is collected as a user walks around an interior or an exterior of a premises. In embodiments, a computing device collects the data using one or more sensors included in the computing device.

The operation 606 includes generating a boundary map based on the sensor data. In example embodiments, the sensor data is input into a localization algorithm, and the localization algorithm generates the boundary map. For example, the localization algorithm may include a Simultaneous Localization and Mapping algorithm. In another example, the localization algorithm may include an Adaptive Monte Carlo Localization algorithm. In some embodiments, a computing device generates the boundary map. In alternative embodiments, the computing device may transmit the sensor data to a server, and the server may generate the boundary map.

The operation 608 includes defining an authentication zone in the boundary map. In examples, the authentication zone may be defined as an area exterior to the premises within a ten-foot radius from the lockset. In alternative examples, the authentication zone may be defined using other processes. Examples of other process for defining an authentication zone are described in U.S. Provisional Patent Application No. 63/635,860, entitled “System for Determining an Authentication Zone for an Electronic Lockset”, the disclosure of which is hereby incorporated by reference in its entirety. In some embodiments, a computing device may define the authentication zone in the boundary map. In alternative embodiments, a server may define the authentication zone in the boundary map.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. An electronic lockset comprising:
a communication interface;
a processor; and
a memory storing instructions that, when executed by the processor, cause the electronic lockset to:
initiate a ranging communication with a computing device using the communication interface;
determine, based on the ranging communication, a first position of the computing device relative to the electronic lockset;
determine, using a predefined boundary map, whether the first position is within an authentication zone defined in the boundary map relative to the electronic lockset, wherein the boundary map is generated based on sensor data collected by the computing device;
in response to a determination that the first position is within the authentication zone, determine, based on the ranging communication, a plurality of second positions of the computing device relative to the electronic lockset, wherein the plurality of second positions is indicative of movement of the computing device relative to the electronic lockset;
determine, based on the plurality of second positions, whether the computing device is approaching the electronic lockset; and
based on a determination that the computing device is approaching the electronic lockset, unlock the electronic lockset.

2. The electronic lockset of claim 1, the instructions, when executed by the processor, further cause the electronic lockset to:
determine, based on the ranging communication, a third position of the computing device relative to the electronic lockset;
determine, using the predefined boundary map, whether the third position is within the authentication zone;
in response to a determination that the third position is within the authentication zone, determine, based on the ranging communication, a plurality of fourth positions of the computing device relative to the electronic lockset, wherein the plurality of fourth positions is indicative of movement of the computing device relative to the electronic lockset;
determine, based on the plurality of fourth positions, whether the computing device is moving away from the electronic lockset; and
based on a determination that the computing device is moving away from the electronic lockset, lock the electronic lockset.

3. The electronic lockset of claim 2, wherein to unlock the electronic lockset includes to:
receive an unlock command; and
execute the unlock command, and
wherein to lock the electronic lockset includes to:
receive a lock command; and
execute the lock command.

4. The electronic lockset of claim 1, wherein the sensor data includes at least one of GPS data captured by the computing device or inertial measurement unit data captured by the computing device.

5. The electronic lockset of claim 4, wherein generation of the boundary map is further based on satellite image data.

6. The electronic lockset of claim 4, wherein a localization algorithm generates the boundary map based on the sensor data.

7. The electronic lockset of claim 1, wherein generation of the boundary map is further based on ranging data captured during a prior ranging communication between the computing device and the electronic lockset.

8. The electronic lockset of claim 1, wherein the sensor data includes images captured by the computing device.

9. The electronic lockset of claim 1, wherein the boundary map is generated based on sensor data captured outside of a setup process of the electronic lockset.

10. The electronic lockset of claim 1, wherein the communication interface is an ultra-wide band communication interface.

11. A system for controlling an electronic lockset, the system comprising:
a communication interface;
a processor; and
a memory storing instructions that, when executed by the processor, cause the system to:
initiate a ranging communication with an electronic lockset using the communication interface;
determine, based on the ranging communication, a first position of the system relative to the electronic lockset;
determine, using a predefined boundary map, whether the first position is within an authentication zone defined in the boundary map relative to the electronic lockset, wherein the boundary map is generated based on sensor data collected by the system;
in response to a determination that the first position is within the authentication zone, determine, based on the ranging communication, a plurality of second positions of the system relative to the electronic lockset, wherein the plurality of second positions is indicative of movement of the system relative to the electronic lockset; and
determine, based on the plurality of second positions, whether the system is approaching the electronic lockset,
wherein the electronic lockset is unlocked based on a determination that the system is approaching the electronic lockset.

12. The system of claim 11, wherein the instructions, when executed by the processor, further cause the system to:
determine, based on the ranging communication, a third position of the system relative to the electronic lockset;
determine, using the predefined boundary map, whether the third position is within the authentication zone;
in response to a determination that the third position is within the authentication zone, determine, based on the ranging communication, a plurality of fourth positions of the system relative to the electronic lockset, wherein the plurality of fourth positions is indicative of movement of the system to the electronic lockset; and
determine, based on the plurality of fourth positions, whether the system is moving away from the electronic lockset,
wherein the electronic lockset is locked based on a determination that the system is moving away from the electronic lockset.

13. The system of claim 11, wherein the sensor data includes at least one of GPS data captured by the system or inertial measurement unit data captured by the system, and
wherein a localization algorithm generates the boundary map based on the sensor data.

14. The system of claim 11, wherein generation of the boundary map is further based on ranging data captured during a prior ranging communication between the system and the electronic lockset 15. The system of claim 11, wherein the sensor data includes images captured by the system.

16. A method of controlling an electronic lockset, the method comprising:
initiating a ranging communication between an electronic lockset and a computing device,
determining, based on the ranging communication, a first position of the computing device relative to the electronic lockset;
determining, using a predefined boundary map, whether the first position is within an authentication zone defined in the boundary map relative to the electronic lockset, wherein the boundary map is generated based on sensor data collected by the computing device;
in response to determining that the first position is within the authentication zone, determining, based on the ranging communication, a plurality of second positions of the computing device relative to the electronic lockset, wherein the plurality of second positions is indicative of movement of the computing device relative to the electronic lockset;
determining whether the computing device is approaching the electronic lockset; and
in response to determining that the computing device is approaching the electronic lockset, unlocking the electronic lockset.

17. The method of claim 16, further comprising:
determining, based on the ranging communication, a third position of the computing device relative to the electronic lockset;
determining, using the predefined boundary map, whether the third position is within the authentication zone;
in response to determining that the third position is within the authentication zone, determining, based on the ranging communication, a plurality of fourth positions of the computing device relative to the electronic lockset, wherein the plurality of fourth positions is indicative of movement of the computing device relative to the electronic lockset;
determining, based on the plurality of fourth positions, whether the computing device is moving away from the electronic lockset; and
in response to determining that the computing device is moving away from the electronic lockset, locking the electronic lockset.

18. The method of claim 16, wherein the sensor data includes at least one of GPS data captured by the computing device or inertial measurement unit data captured by the computing device.

19. The method of claim 18, wherein a localization algorithm generates the boundary map based on the sensor data.

20. The method of claim 16, wherein the sensor data includes images captured by the computing device, and wherein generation of the boundary map is further based on ranging data captured during a prior ranging communication between the computing device and the electronic lockset.
